(19) United States
(12) Patent Application Publication
(10) Pub. No.: US 2006/0256864 A1
(43) Pub. Date: Nov. 16, 2006

(54) Motion estimation methods and systems in video encoding for battery-powered appliances

(75) Inventor: Chi-Cheng Ju, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/129,536

(22) Filed: May 13, 2005

(51) Int. Cl. H04N 7/12; H04N 11/02; H04N 11/04; H04B 1/66

(52) U.S. Cl. 375/240.12; 375/240.24

(57) ABSTRACT

Methods and systems for motion estimation in video encoding. A power level within a battery is detected. One motion estimation process among multiple motion estimation processes is determined for an array of pixels contingent upon the power level detected within the battery. The determined motion estimation process is performed on the pixel array.

### BACKGROUND

The invention relates to video encoding, and more particularly, to video encoding methods and devices for handheld apparatuses.

Video encoding methods have been evaluated regarding compression efficiency. The objectives of the first video standards are the storage of films on a CD (MPEG-1), the broadcast of television programs on cable/satellite (MPEG-2) and the stemming/downloading of video contents over the Internet (MPEG-4). The constraints are bandwidth and storage capacity. The evaluation criterion is the computational complexity, especially in applications where real-time encoding is necessary. Typically, compression efficiency is still important, while computational complexity becomes less and less problematic due to the increasing speed of processors. In new applications, especially in handheld devices, power consumption is becoming increasingly important. Handheld devices, such as personal digital assistants (PDAs) or mobile phones, are expected to offer video encoding capabilities in the near future.

Typically, the power consumption is either controlled from an architectural perspective or an algorithmic perspective. For example, the paper entitled “An 80/20 MHz 160 mW multimedia processor integrated with embedded DRAM, MPEG-4 accelerator and 3-D rendering engine for mobile application”, by C. W. Yoon et al., IEEE Journal of Solid-State Circuits, Volume: 36, Issue: 11, pp. 1758-1767, November 2001, describes a low power consumption video device. The device comprises embedded memories that are located close to the central processing unit (CPU) and co-processors, such that an access to their data goes through less cable and dissipates less energy. The paper entitled “Motion Estimation for Low Power Video Devices”, by C. De Vleeschouwer, T. Nilsson, in International Conference on Image Processing, 2001, Vol. 2, 2001, pp. 953-956, describes a low power method. In this document, the low power consumption is achieved by reducing memory accesses and transfers.

### SUMMARY

Methods in video encoding for battery-powered appliances are provided. An embodiment of a method comprises detecting a power level within a battery of a battery-powered appliance, determining one motion estimation process among multiple motion estimation processes for an array of pixels contingent upon the power level detected within the battery, and performing the determined motion estimation process on the array of pixels.

Systems capable of encoding video data are provided. An embodiment of a video encoding system comprises a battery, a detection unit, and an encoder. The detection unit is coupled to the battery and detects a power level within the battery. The encoder, coupled to the detection unit, determines one motion estimation process among multiple motion estimation processes for an array of pixels contingent upon the power level detected within the battery, and performs the determined motion estimation process on the array of pixels.

### BRIEF DESCRIPTION OF THE DRAWINGS

The invention will become more fully understood by referring to the following detailed description of embodiments with reference to the accompanying drawings, wherein:

FIG. 1 is a diagram showing a structure of an exemplary MPEG-2 video bitstream;

FIG. 2 is a diagram showing picture architecture of an exemplary MPEG-2 video bitstream;

FIG. 3 is a diagram illustrating an exemplary bidirectional predication;

FIG. 4 is a diagram illustrating exemplary pyramidal images;

FIG. 5 is a diagram of a hardware environment applicable to an embodiment of a battery-powered appliance;

FIG. 6 is a diagram applicable to an embodiment of a video encoder;

FIGS. 7 and 8 are flowcharts showing embodiments of methods for motion estimation.

### DESCRIPTION

A digital video stream includes a series of still pictures, requiring considerable storage capacity and transmission bandwidth. A 90-min full color video stream, having a resolution of 640×480 pixels/picture rendered at a rate of 15 pictures/sec, requires bandwidth of 640×480 pixels/picture×3 bytes/pixel×15 pictures/sec=13.18 MB/sec and file size of 13.18 MB/sec×90×60=69.50 GB, for example. Such a sizeable digital video stream is difficult to store and transmit in real time, thus, many compression techniques have been introduced. MPEG standards ensure video encoding systems create standardized files that can be opened and played on any system with a standards-compliant decoder. Digital video contains spatial and temporal redundancies, which may be compressed without significant sacrifice. MPEG encoding is a generic standard, intended to be independent of a specific application, involving compression based on statistical redundancies in temporal and spatial directions. Spatial redundancy is based on the similarity in color values shared by adjacent pixels. MPEG employs intra-picture spatial compression on redundant color values using DCT (Discrete Cosine Transform) and quantization. Temporal redundancy refers to identical temporal motion between video pictures, providing smooth, realistic motion in video. MPEG relies on prediction, more precisely, motion-compensated prediction, for temporal compression between pictures. To create temporal compression, MPEG utilizes I-pictures (Intra-coded pictures), B-pictures (bidirectionally predictive-coded pictures) and P-pictures (predictive-coded pictures). I-picture is an intra-coded picture, a single image heading a sequence, with no reference to previous or subsequent pictures. MPEG-1 compresses only within the picture with no reference to previous or subsequent pictures. P-pictures are forward-predicted pictures, encoded with reference to a previous I- or P-picture, with pointers to information in a previous picture. B-pictures are encoded with reference to a previous reference picture, a subsequent reference picture, or both. Motion vectors employed may be forward, backward, or both.

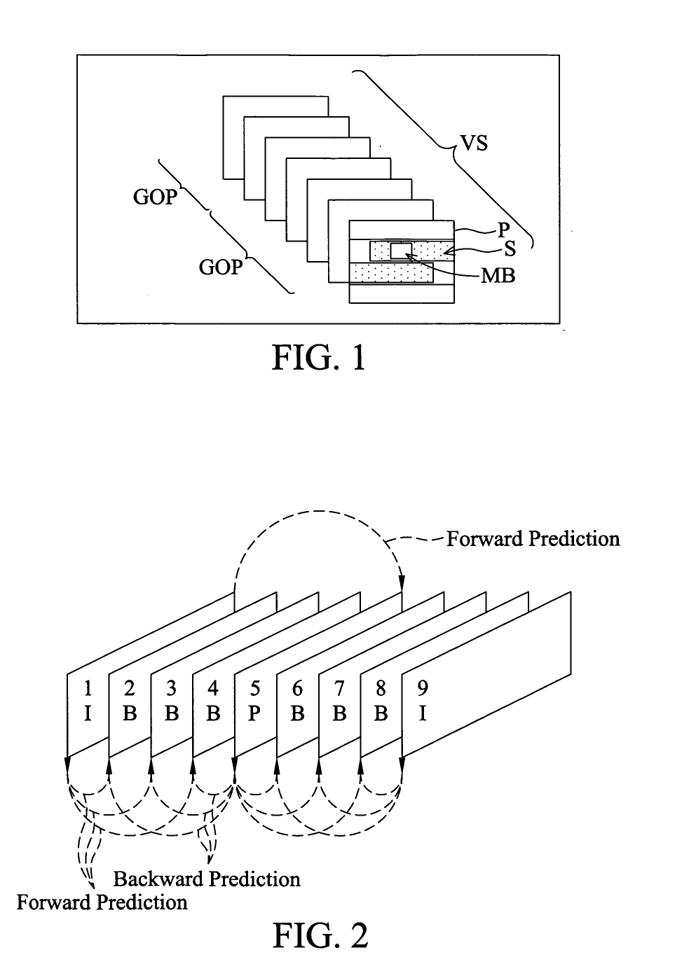

FIG. 1 is a diagram showing a structure of an exemplary MPEG-2 video bitstream. A video stream (VS) is composed of multiple pictures or groups of pictures (GOPs). The picture, a basic unit in compression, includes three types of picture, I-picture, P-picture, and B-picture. Each picture is divided horizontally into fixed lengths to produce multiple slices (Ss) as the minimum unit in signal synchronization and error control. Each S, composed of multiple macroblocks (MBs) at 16×16 pixels, is the minimum unit in color sampling, motion estimation and motion compensation. Each MB, composed of four blocks of 8×8 pixels is the minimum unit in DCT.

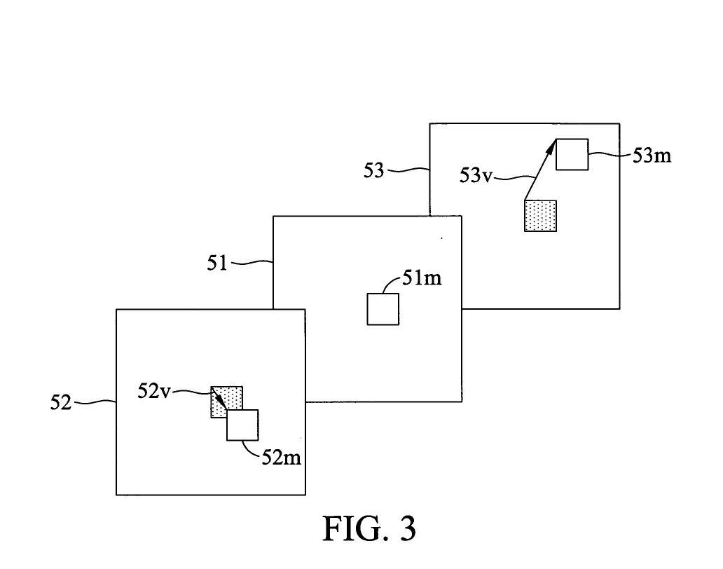

FIG. 2 is a diagram showing picture architecture of an exemplary MPEG-2 video bitstream. In MPEG-2 video, I-picture has no reference picture, and is compressed by quantization and variable length coding methods, thus, it can be treated as an initiation point for decompression without other pictures. The I-picture is the first picture in the VS or GOP, and those following are P-pictures and B-pictures. Hence, I-pictures require protection during file transfer to prevent data loss and further damage to subsequent pictures. A P-picture refers to one reference picture, such as an I-picture or prior P-picture, to locate similar MBs. When there is no similar MB, the MBs in the P-picture can be compressed using intra-coding. Basically, P-pictures are composed of both intra-coded MBs and predictive-coded MBs, where the content of the predictive-coded MB is a motion vector and calculated according to the reference picture. A B-picture refers to both subsequent and previous reference pictures to locate similar MBs.

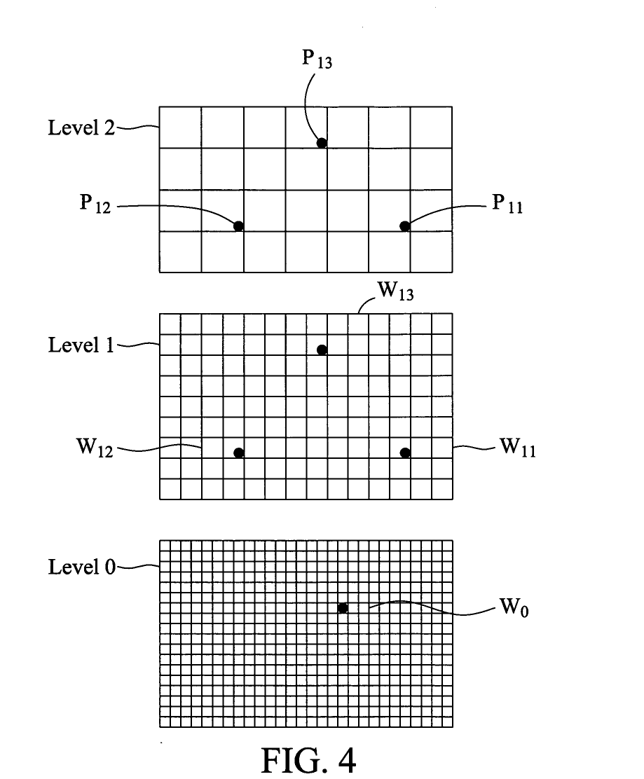

In a sequence of pictures, the current picture is predicted from a previous picture known as reference picture. However, motion estimation techniques may choose different block sizes, and may vary the size of the blocks within a given picture. Each MB is compared to a MB in the reference picture using some error measure, and the best matching MB is selected. The search is conducted over a predetermined search area. A motion vector denoting the displacement of the MB in the reference picture with respect to the MB in the current picture, is determined. When a previous picture is used as a reference, the prediction is referred to as forward prediction. If the reference picture is a future picture, the prediction is referred to as backward prediction. Backward prediction is typically used with forward prediction, and is referred to as bidirectional prediction. FIG. 3 is an exemplary diagram of bidirectional prediction. In B-picture 51, the bi-directional motion-compensated MB 51m can have two motion vectors, the forward motion vector 52v which references the best matching block 52m in the previous I- or P-picture 52, and the backward motion vector 53v which references the best matching block 53m in the next I- or P-picture 53.

Motion estimation processes are used to eliminate the large amount of temporal and spatial redundancy that exists in video sequences. The better the estimation, the smaller the error and the transmission bit rate. If a scene is still, then a good prediction for a particular MB in the current picture is the same MB in the previous or next picture and the error is zero. There are various motion estimation processes, such as full search and hierarchical search block-matching processes, for interpicture predictive coding. In the embodiments here described, a motion estimation process is selected among various motion estimation processes according to the current power level within the battery of a battery-powered appliance. When the current power level is high, a computationally complex and more accurate motion estimation process is used. When the current power level is low, a computationally simple and less accurate motion estimation process is used.

Moreover, to evaluate the “goodness” of a match between a prediction block in the reference picture and an MB being encoded in the current picture, there are also many various matching criteria, such as CCF (cross correlation function), PDC (pel difference classification, MAD (mean absolute difference), MSD (mean squared difference), IP (integral projection) and the like. Some matching criteria are simple to evaluate and therefore consume less power, while others are more complicated and therefore consume more power. In the exemplary embodiments, a motion estimation process can use different matching criteria for MB comparison according to the current power level within the battery of a battery-powered appliance. When the current power level is high, a computationally complex and more accurate matching criterion is used. When the current power level is low, a computationally simple and less accurate matching criterion is used.

In a full search block-matching process, each MB within a given search window is compared to the current MB and the best match is obtained (based on one comparison criterion). Although, this process is the best in terms of the quality of the predicted image and the simplicity of the algorithm, it consumes the most power. Since the motion estimation is the most computationally intensive and power consuming operation in the coding of video streams, various signature-based search block-matching processes, such as hierarchical search, TSS (three step search), TDL (two dimensional logarithmic search), BS (binary search), FSS (four step search), OSA (orthogonal search algorithm), OTA (one at a time algorithm), CSA (cross search algorithm), DS (diamond search) and the like, are introduced. There is, however, a trade-off between the efficiency of the process and the quality of the prediction image.

To reduce the power consumption in motion estimation, coarse-to-fine hierarchical searching block-matching processes is preferably adopted. This reduction in the power consumption is due to the reduced image size at higher level. One of the well-known examples of these processes is the mean pyramid. In the mean pyramid methods, different pyramidal images are constructed by sub-sampling. Then a hierarchical search motion vector estimation proceeding from the higher level to the lower levels reduces the computational complexity and obtains high quality motion vectors. To remove the effects of noise at a higher level, image pyramids are constructed using a low pass filter. A simple averaging is used to construct the multiple-level pyramidal images. For example, a pyramid of images can be built by the following equation:

$${g}_{L} ( p , q ) = ⌈ ( 1 / 4 ) \cdot ( {\sum }_{u = 0}^{1} {\sum }_{v = 0}^{1} {g}_{L - 1} ( 2 p + u , 2 q + v ) ) ⌉$$

where g_{L}(p, q) represents the gray level at the position (p, q) of the Lth level and g₀(p, q) denotes the original image. The construction of mean pyramid by simple non-overlapping low pass filtering is completely by assigning a mean gray level of pixels in a low pass window to a single pixel at the next level. The truncated mean value of four pixels at the lower level is recursively used in generating mean pyramid.

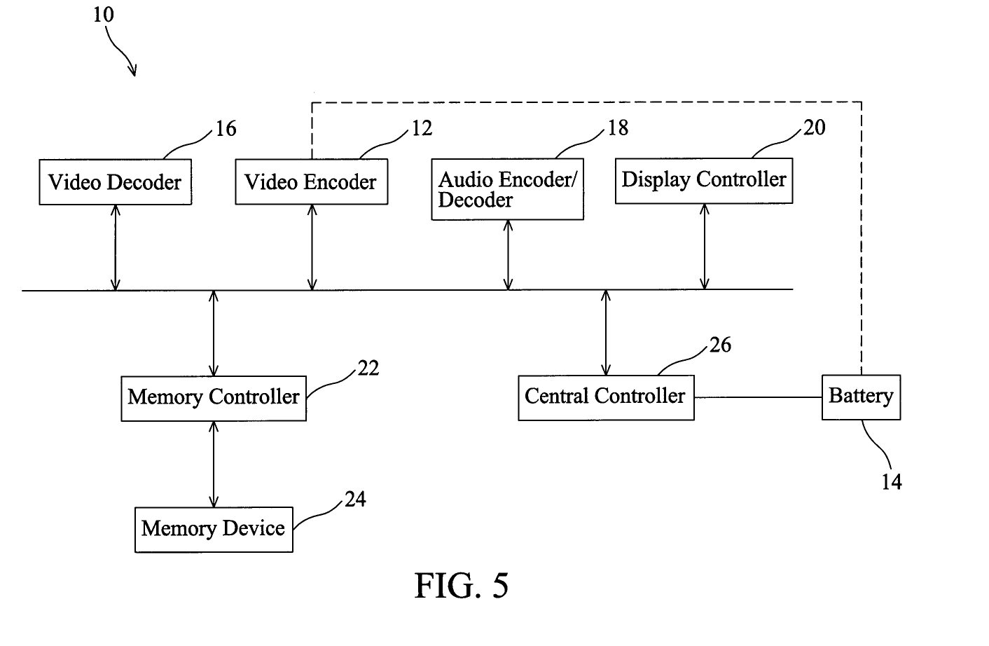

An example is introduced to show a hierarchical search process using three levels. Each pixel at level 2 corresponds to a 4×4 block and 2×2 block at level 0 and 1, respectively. Therefore, a block of size 16×16 at level 0 is replaced by a one of size 16/2 L×16/2 L at level L. After construction of a mean pyramid, these images can be searched using the three step search (TSS) where the motion vectors are searched at level 2 with MAD (Minimum Absolute Difference) and the motion vector having the smallest MAD is selected as the coarse motion vector at that level. That is the detected motion vector at the higher level is transmitted to the lower level and it guides the refinement step at that level. This hierarchical search process is repeated once more down to level 0. Since MADs are computed at the highest level based on relatively small blocks, almost the same values are likely to appear at several points. Thus, more than one candidate is used at the highest level (level 2 for a special case). A number of motion vectors at level 2 are propagated to the lower one. Full search with two pixel resolution in a small window around the candidates is used at level one to find the minimum difference location as the search center at level 0. FIG. 4 is a diagram illustrating exemplary pyramidal images. First, three best matched points P₁₁ to P₁₃ are selected as centers for search windows at the next level (i.e. level 1). Search windows w₁₁ to w₁₃ are selected as potential locations for finding the best match at level 1. Finally, search window w₀ is selected as the best location to find a match at level 0.

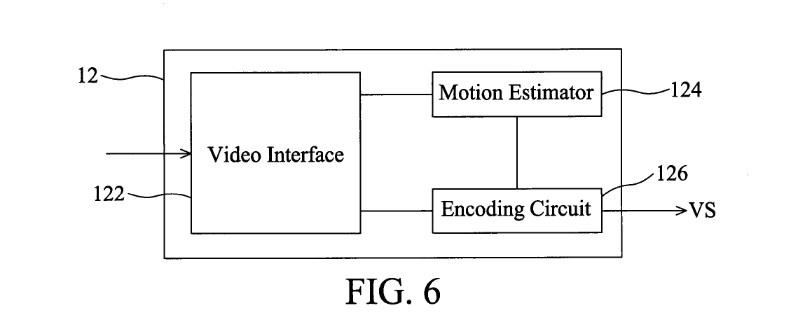

FIG. 5 is a diagram of a hardware environment applicable to an embodiment of a battery-powered appliance 10, comprising a video encoder 12, a battery 14, a video decoder 16, an audio encoder/decoder 18, a display controller 20, a memory controller 22, a memory device 24, and a central controller 26. The battery 14 is a main power source or auxiliary power source for the device 10. The memory device 24 is preferably a random access memory (RAM), but may also include read-only memory (ROM) or flash ROM. The memory device 24 temporarily stores data for video encoding. Typically, large temporary data requires more storage capability of memory device 24, leading to greater power consumption of the battery 14. The central controller 26 controls the video decoder 16, video encoder 12, audio encoder/decoder 18, display controller 20 and memory controller 22 to direct video encoding functions. Note that the battery 14 may couple to the central controller 26 rather than to the video encoder 16 for battery level detection, and the video encoder 16 may acquire the battery level by querying the central controller 26.

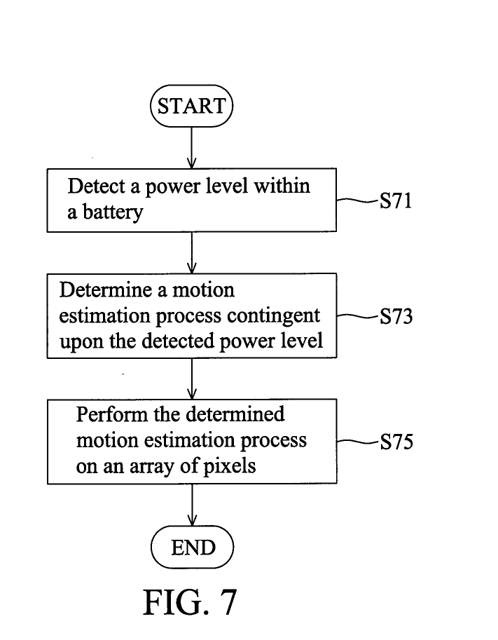

FIG. 6 is a diagram applicable to an embodiment of a video encoder 12, comprising a video interface 122, a motion estimator 124, and encoding circuit 126. The video encoder 12 encodes digitized video data to generate a video bitstream VS. The motion estimator 124, coupling to the video interface 122, performs various motion estimation methods for MBs in the digitized video data. The encoding circuit 126, coupling to the video interface 12.2 and motion estimator 124, controls the entire encoding process, encodes estimated pictures using DCT, Quantization, VLC or others, to generate a VS, and generates reference pictures for motion estimation using Inverse Quantization, Inverse DCT (IDCT), Motion Compensation (MC) or others.

Referring to FIG. 5, if the battery 14 is full or near full, the video encoder 12 is adapted to be more power consuming, yielding a better video quality. If the battery 14 is near empty, the video encoder 12 is adapted to be less power consuming in order to provide longer battery life while gradually reducing the quality of the video. Conversely, if the battery level becomes low, the battery-powered appliance will still be able to encode instead of shutting down, but at lower quality.

Generally, performing a full search block-matching process requires larger memory bandwidth, leading to more power consumption, and otherwise, performing a hierarchical search process requires smaller memory bandwidth, leading to less power consumption. Thus, if the battery 14 is full or near full, the video encoder 12 provides full capacity to perform a full search block-matching process, yielding a better video quality. If the battery 14 is near empty, the video encoder 12 performs a hierarchical search process in order to provide longer battery life while gradually reducing the quality of the video. During a hierarchical search process, searching through more levels requires less memory bandwidth, leading to lower power consumption, and conversely, searching through fewer levels in a hierarchical search process requires larger memory bandwidth, leading to more power consumption. When a hierarchical search or full search block-matching process is performed, searching a larger range requires larger memory bandwidth, leading to more power consumption, and conversely, searching a smaller range requires less memory bandwidth, leading to lower power consumption.

In FIG. 5, an embodiment of the video encoder 12 acquires a power level within the battery 14, determines one motion estimation process among multiple motion estimation processes for an array of pixels contingent upon the power level, and performs the determined motion estimation process on the pixel arrays. The motion estimation processes may comprise hierarchical search and full search block-matching processes. In some examples, the video encoder 12 may select the full search block-matching process when the power level detected within the battery is greater than a threshold, and, if required, further determine a search range for the full search block-matching process in accordance with the detected power level. Moreover, the video encoder 12 may determine a criterion for block matching in accordance with the detected power level. However, the video encoder 12 may select the hierarchical search process when the power level detected within the battery is lower than or equal to the threshold, and, if required, further determine a total number of levels and a search range for each level of the hierarchical search process in accordance with the detected power level. Moreover, the video encoder 12 may determine a criterion for block matching accordance with the detected power level.

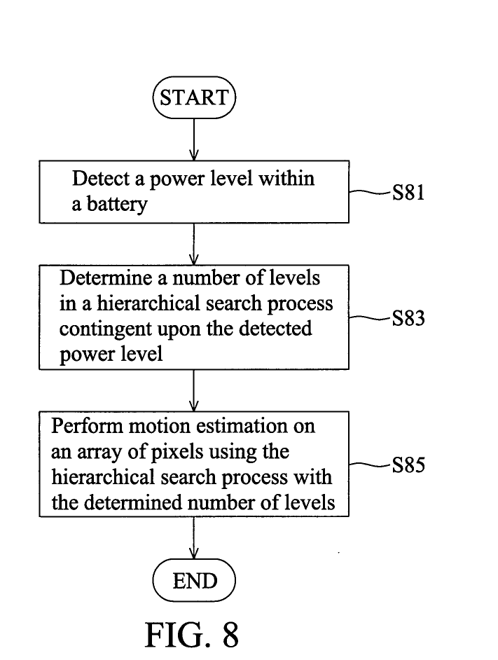

FIG. 7 is a flowchart showing an embodiment of a method for motion estimation. In step S71, a power level within a battery is detected. In step S73, one motion estimation process among multiple motion estimation processes for an array of pixels is determined contingent upon the detected power level. The motion estimation processes may comprise hierarchical search and full search block-matching processes. In some examples, the full search block-matching process may be selected when the power level detected within the battery is greater than a threshold, and, if required, a search range for the full search block-matching process is further determined in accordance with the detected power level. Moreover, a criterion for block matching is determined in accordance with the detected power level. The hierarchical search process may otherwise be selected when the power level detected within the battery is lower than or equal to a threshold, and, if required, a total number of levels and a search range for each level of the hierarchical search process is further determined in accordance with the detected power level. Also, a criterion for block matching is determined in accordance with the detected power level. In step S75, the determined motion estimation process is performed on the array of pixels.

Still referring to FIG. 5, an embodiment of the video encoder 12 may acquire a power level within the battery 14, determines the number of levels of a hierarchical search process for an array of pixels contingent upon the detected power level, and performs motion estimation on the array of pixels using the hierarchical search process with the determined number of levels. In some examples, the video encoder 12 may determine fewer levels for the hierarchical search process upon detection of a higher power level, and otherwise, determine more levels for the hierarchical search process upon detection of a lower power level. In some examples, when the number of levels is determined for a hierarchical search process, the video encoder 12 may further determine respective search ranges for the determined levels of the hierarchical search process contingent upon the detected power level, and perform the hierarchical search process with the determined search ranges at separate pyramid levels.

FIG. 8 is a flowchart showing an embodiment of a method for motion estimation. In step S81, a power level within a battery is detected. In step S83, the number of levels of a hierarchical search process is determined for an array of pixels contingent upon the detected power level. In some examples, fewer levels may be determined for the hierarchical search process upon detection of a higher power level, and otherwise, more levels may be determined for the hierarchical search process upon detection of a lower power level. In step S85, motion estimation is performed on the array of pixels using the hierarchical search process with the determined number of levels. In some examples, when the number of levels is determined for a hierarchical search process, respective search ranges for the determined levels of the hierarchical search process may also be determined contingent upon the detected power level, and the hierarchical search process is performed with the determined search ranges at separate pyramid levels.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method of motion estimation in video encoding for a battery-powered appliance, comprising:
detecting a power level within a battery;
determining one motion estimation process among a plurality of motion estimation processes for an array of pixels contingent upon the power level detected within the battery; and
performing the determined motion estimation process on the array of pixels.

2. The method of claim 1 wherein the motion estimation processes comprise hierarchical search and full search block-matching processes.

3. The method of claim 2 wherein determining the one motion estimation process comprises selecting the full search block-matching process when the power level detected within the battery is greater than a threshold.

4. The method of claim 3 further comprising determining a search range for the full search block-matching process in accordance with the power level detected within the battery.

5. The method of claim 3 wherein determining the one motion estimation process further comprises selecting the hierarchical search process when the power level detected within the battery is lower than or equal to the threshold.

6. The method of claim 5 further comprising determining a total number of levels and a search range of each level for the hierarchical search process in accordance with the power level detected within the battery.

7. The method of claim 1 further comprising determining a criterion for block matching in accordance with the power level detected within the battery.

8. A method of motion estimation in video encoding for a battery-powered appliance, comprising:
detecting a power level within a battery;
determining the number of levels of a hierarchical search process for an array of pixels contingent upon the power level detected within the battery; and
performing motion estimation on the array of pixels using the hierarchical search process with the determined number of levels.

9. The method of claim 8 wherein determining the number of levels further comprises determining fewer levels for the hierarchical search process when a higher power level is detected in the battery.

10. The method of claim 8 further comprising determining a plurality of search ranges respectively for levels of the hierarchical search process contingent upon the power level detected within the battery.

11. The method of claim 10 wherein the performing motion estimation uses the search ranges at the levels of the hierarchical search process, respectively.

12. The method of claim 8 further comprising determining a criterion for block matching in accordance with the power level detected within the battery.

13. A system capable of encoding video data, comprising:
a battery;
a detection unit coupled to the battery and detecting a power level within the battery; and
an encoder coupled to the detection unit, determining one motion estimation process among a plurality of motion estimation processes for an array of pixels contingent upon the power level detected within the battery, and performing the determined motion estimation process on the array of pixels.

14. The system of claim 13 wherein the motion estimation processes comprise hierarchical search and full search block-matching processes.

15. The system of claim 14 wherein the encoder further selects the full search block-matching process when the power level detected within the battery is greater than a threshold.

16. The system of claim 15 wherein the encoder further determines a search range for the full search block-matching process in accordance with the power level detected within the battery.

17. The system of claim 15 wherein the encoder further selects the hierarchical search process when the power level detected within the battery is lower than or equal to the threshold.

18. The system of claim 17 wherein the encoder further determines a total number of levels and a search range of each level for the hierarchical search process in accordance with the power level detected within the battery.

19. The system of claim 13 the encoder further determines a criterion for block matching in accordance with the power level detected within the battery.

20. A system capable of encoding video data, comprising:
a battery;
a detection unit coupled to the battery and detecting a power level within the battery; and
an encoder coupled to the detection unit, determining the number of levels of a hierarchical search process for an array of pixels contingent upon the power level detected within the battery, and performing motion estimation on the array of pixels using the hierarchical search process with the determined number of levels.

21. The system of claim 20 wherein the encoder determines fewer levels for the hierarchical search process when a higher power level is detected in the battery.

22. The system of claim 20 wherein the encoder determines a plurality of search ranges respectively for the levels of the hierarchical search process contingent upon the power level detected within the battery.

23. The system of claim 22 wherein the encoder performs motion estimation further using the search ranges at the levels of the hierarchical search process, respectively.

24. The system of claim 20 wherein the encoder further determines a criterion for block matching in accordance with the power level detected within the battery.
